(19) United States
(12) Patent Application Publication
(10) Pub. No.: US 2026/0261650 A1
(43) Pub. Date: Sep. 3, 2026

(54) INTRA-CODING VIDEO TECHNIQUES USING NEURAL NETWORKS

(71) Applicant: DOLBY LABORATORIES LICENSING CORPORATION

(72) Inventors: Thuong NGUYEN CANH, San Mateo, CA (US); Zongyao LYU, Arlington, TX (US); Tong SHAO, Sunnyvale, CA (US)

(73) Assignee: DOLBY LABORATORIES LICENSING CORPORATION, (US)

(21) Appl. No.: 19/550,968

(22) Filed: Feb. 26, 2026

Related U.S. Application Data
(60) Provisional application No. 63/765,138, filed on Feb. 28, 2025.

(51) Int. Cl. H04N 19/105; H04N 19/159; H04N 19/176; H04N 19/182

(52) U.S. Cl. CPC H04N 19/105; H04N 19/159; H04N 19/176; H04N 19/182

(57) ABSTRACT

Neural networks (NNs) are described for intra-coding in video coding when reference samples from neighbor blocks are missing. In one architecture, multiple different neural networks are being used for intra coding, each trained depending on the location of the missing samples. In another architecture, a two-network approach is proposed: one NN to adaptively generate reference samples using an array of multi-layer perceptrons (MLPs), and the second NN to generate predicted pixel values based on the concatenated output values of the MLPs. Intra-coding performance may also be improved using a separate post-processing neural network to take advantage of spatial pixel correlation.

### CROSS-REFERENCE TO RELATED APPLICATIONS

This application claims the benefit of priority from U.S. Provisional patent application 63/765,138, filed on Feb. 28, 2026, which is hereby incorporated by reference. TECHNOLOGY

The present document relates generally to images and video coding. More particularly, embodiments of the present invention relate to intra-coding techniques in video coding using neural networks (NNs).

### BACKGROUND

In 2020, the MPEG group in the International Standardization Organization (ISO), jointly with the International Telecommunications Union (ITU), released the first version of the Versatile Video Coding Standard (VVC), also known as H.266 (Ref. [1]). More recently, the same group has been working on the development of the next generation coding standard that provides improved coding performance over existing video coding technologies. As part of this investigation, new coding techniques are also examined.

As appreciated by the inventors here, improved techniques for video coding are desired, and they are described herein.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not be assumed to have been recognized in any prior art on the basis of this section, unless otherwise indicated.

### BRIEF DESCRIPTION OF THE DRAWINGS

An embodiment of the present invention is illustrated by way of example, and not in way by limitation, in the figures of the accompanying drawings and in which like reference numerals refer to similar elements and in which:

FIG. 1 depicts an example pixel structure for intra prediction according to an embodiment of this invention;

FIG. 2A depicts an example process flow for neural-networks-based intra prediction according to an embodiment of this invention;

FIG. 2B depicts an example process flow for neural-networks-based intra prediction with additional post-processing according to an embodiment of this invention;

FIG. 3 depicts an example process flow for a neural-networks-based intra prediction according to an alternative embodiment of this invention

### DESCRIPTION OF EXAMPLE EMBODIMENTS

Example embodiments that relate to intra-coding prediction in video coding are described herein. In the following description, for the purposes of explanation, numerous specific details are set forth in order to provide a thorough understanding of the various embodiments of the present invention. It will be apparent, however, that the various embodiments of the present invention may be practiced without these specific details. In other instances, well-known structures and devices are not described in exhaustive detail, in order to avoid unnecessarily occluding, obscuring, or obfuscating embodiments of the present invention.

### SUMMARY

Example embodiments described herein relate to intra-coding prediction in video coding, especially when there are missing reference samples. In one embodiment, multiple separate neural networks are being used for intra coding, each trained depending on the location of the missing reference samples. For example, in a three-network architecture, network A handles cases where only Top, Top Left, and Left samples available (e.g., Top Right and Left Bottom samples are missing), network B handles cases where only Top, Top Left, Top Right, and Left samples available (e.g., Left Bottom samples are missing), and network C handles cases where all reference samples are available.

In another embodiment, a two-network approach is proposed: one NN to adaptively generate reference samples using an array of Multi-Layer Perceptrons (MLPs), and the second NN to generate predicted pixel values based on the concatenated output values of the MLPs.

Intra-coding performance may also be improved using a separate post-processing neural network (NN) to take advantage of spatial pixel correlation. The post-processing NN may be trained in combination with the other neural networks.

### Intra Prediction in Video Coding

In modern image and video coding standards, given a picture sub-divided into blocks of spatial data, the term “intra prediction” refers to a coding method to predict the values of pixels in a codded unit (CU) using pixel values in surrounding blocks that have been already coded. When using intra prediction, coded pictures are referred to as intra-coded pictures.

An intra prediction process typically consists of the following steps:
1. pre-processing of reference samples
2. substitution of missing reference samples
3. smoothing of the reference samples
4. performing intra prediction
5. post-filtering of prediction (to reverse certain pre-processing steps)
6. In an encoder: Generating residuals between the original values and the predicted values, encoding the residuals, and signaling encoded residuals and the intra-prediction mode so that a decoder can reconstruct a close approximation of the original pixel values using the coded residuals and predicted pixel values generated by the decoder.

In a decoder, reference samples comprise samples of blocks in the current picture that have already been decoded. After generating the predicted samples of the current block (steps 1-5), and given the coded residuals, the decoder adds the decoded residuals to the predicted samples to generate reconstructed pixels of the current block.

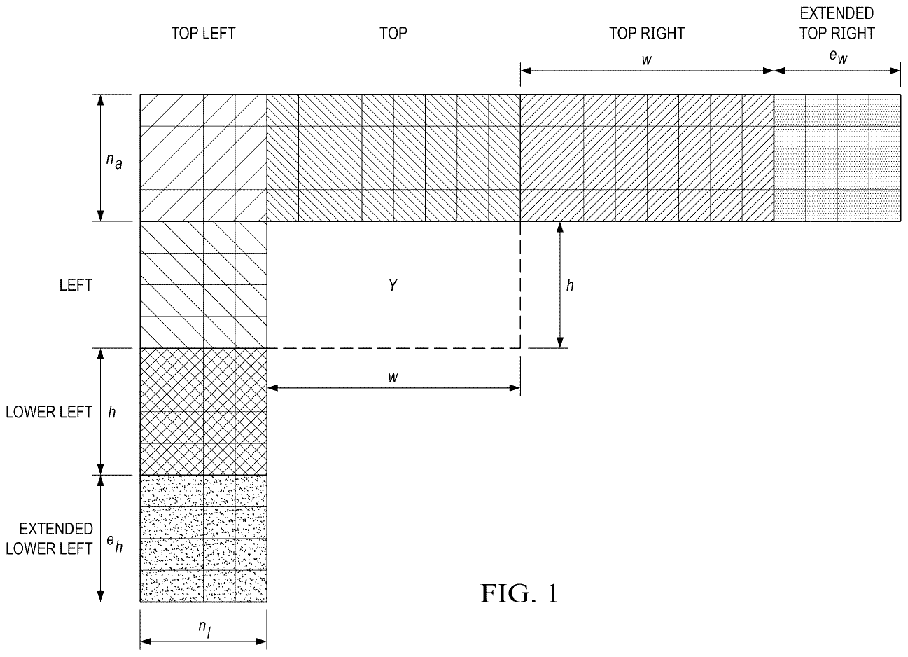

FIG. 1 depicts an example of a typical pixel structure during intra prediction. As depicted in FIG. 1, the goal is to predict pixel values in w×h block Y using neighbor pixels from neighbor blocks to the top left, top, top right, left, and lower left, and in certain embodiments, from an extended top right and extended lower left. Because encoders apply a raster-scan order encoding, coding blocks from the top left corner of an input picture down to the bottom right corner of the picture, only about one third of all coding blocks are coded with a full set of reference samples (Ref. [4]). In the other cases, missing reference pixel values are replaced with substitute pixel values, for example copies of existing reference pixels. This approach ensures continuity and coherence in the prediction process, even when some reference samples are unavailable.

In addition to conventional intra prediction modes such as DC, Planar, and Angular modes, Versatile Video Coding (VVC) introduced Matrix-based Intra Prediction (MIP) (Ref. [2]). MIP operates by utilizing the following steps:
Down-sampling reference samples: The algorithm applies intra prediction on a down-sampled version of the prediction block by using a down-sampled version of the neighbor reconstructed pixels (e.g., neighboring reference pixels may be averaged)
Low-resolution prediction: Using these down-sampled values, MIP performs intra prediction at a lower resolution
Up-scaling: The lower-resolution prediction block is then up-scaled using a simple interpolation method.

After the development of VVC, the JVET group started work on an enhanced compression model (ECM). ECM tools extended intra prediction by allowing 32×32 blocks, but kept the maximum number of lines (e.g., nₐ in FIG. 1) or columns (e.g., nₗ in FIG. 1) of reference pixels as before (at 2) to reduce complexity (Refs [5-7]).

In the exploration of neural network-based video coding (NNVC) beyond VVC, an advanced neural-networks-based framework for intra coding (nnIntra) has been developed (Ref. [3]). This framework incorporates extended top right and lower left reference samples (e.g. e_{w} and eₕ related pixels in FIG. 1) and reference pixels for small coding blocks. The nnIntra prediction process consists of three main steps:
1. Pre-processing: The pre-processing stage involves the following operations: (1) flattening of the reference pixels to a 1-D vector X, (2) normalizing X through bit-depth scaling to 8-bits, (3) substituting any missing reference samples with a value of 255, and (4) subtracting their mean value from the reference samples. In addition, for small coding blocks of 4×4, extended references are added.
   Referring to FIG. 1,

$$\{ \begin{matrix}{n}_{a} = {n}_{l} = min ( h , w ) , & if min ( h , w ) \leq 8 \\ {n}_{a} = h / 2 , {n}_{l} = w / 2 , & otherwise .\end{matrix}$$

2. Neural-network prediction: In this stage, the nnIntra framework (denoted as ƒ_{h,w}(·; θ_{h,w}), parametrized by θ_{h,w}) employs a simple feed forward neural network (NN) with only 2-3 fully connected layers. The total of 7 neural networks are used corresponding to prediction size (4×4, 4×8, 4×16, 4×32, 8×8, 8×16, 16×16). The outputs include predicted intra block \tilde{Y}, LFNST (low frequency, non-separable transform) indices for transform set of {1, 2}, and the intra prediction mode for a most probable mode (MPM) process. Additionally, weight pruning is applied to reduce the computational complexity.
3. Post-processing: The post-processing stage reverses the pre-processing operations with reshaping the predicted 1-D array pixels to 2-D pixels, reversing pixel scaling, and adding back the subtracted mean value to restore pixels values to the original bit depth.

The training process for the nnIntra framework is conducted via four training cycles (Ref. [3]], where each cycle utilizes corresponding training sets and data generation to optimize the training performance with a loss function of

$$ℒ ( x , y ; θ ) = SATD ( y , {f}_{h , w} ( x ; {θ}_{h , w} ) ) + {λ}_{1} \vert {θ}_{h , w} \vert + {λ}_{2} ℒ ( rpIdx , mode ) , \qquad ( 1 )$$

where |θ_{h,w}| denotes the L1 norm of all learned weights, λ₁=5.0e⁻⁵, [symbol] (rpIdx, mode) denotes the cross entropy loss for intra mode prediction, 12=5.0e-4, and SATD stands for sum of absolute transformed differences. The term rpIdx denotes the index characterizing the LFNST kernel index and whether the primary transform coefficients resulting from the application of the DCT-2 horizontally and the DCT-2 vertically to the residue of the neural network prediction are transposed when lfnstIdx=i, i∈{1, 2}. The term mode refers to PLANAR, DC, directional intra prediction modes, or other intra prediction modes.

In the last training cycle, the neural weights for prediction and intra mode are frozen and only the prediction weights for LFNST are trained. Additionally, the loss function in the last training cycle is the cross-entropy loss for LFNST indices.

While the current performance of nnIntra is promising, it still suffers from several limitations that impact its performance, including:
1. Suboptimal handling of predicting a block with missing reference samples. Currently, nnIntra substitutes missing reference sample with a constant value of 255. This approach fails to leverage the spatial context of available reference pixels.
2. Does not take advantage of 2-D spatial correlation. The fully connected layers predict samples as a 1-D signal and ignore the 2-D spatial correlation.

### Adaptive Reference Sample Generation

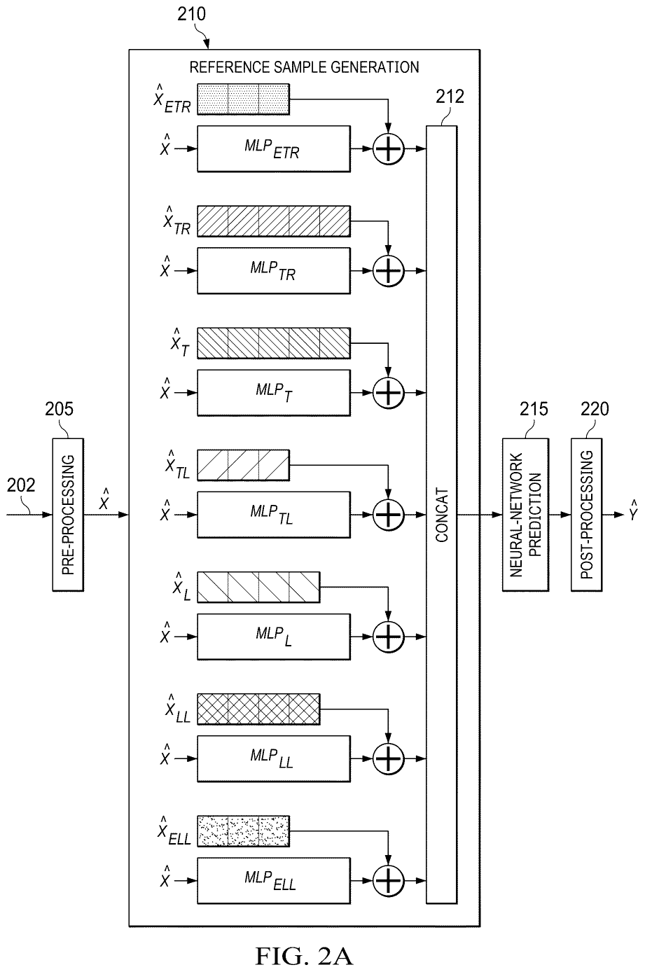

FIG. 2A depicts an example process flow according to an embodiment. As depicted in FIG. 2A, missing reference samples may be handled by adding a reference samples generation network (210). The process involves the following steps:
1. Pre-processing (205)
   Similarly to nnIntra (Ref. [3]), given an input block Y and associated neighboring samples (202) (e.g., see FIG. 1), the available reference samples are normalized by subtracting the mean value of all available reference samples, and any missing reference samples are substituted with a value of zero. These normalized reference samples \hat{X} are grouped based on neighbor region (R) as: top left (TL), top (T), top-right (TR), extended top right (ETR), left (L), lower left (LL), and extended lower-left (ELL). Thus:
      \hat{X} denotes the full set of normalized reference samples
      \hat{X}_{R}=0, denotes there are missing samples in reference region R
      \hat{X}_{R} denotes normalized reference samples in reference region R, when there are no missing reference samples in region R,
   where R∈{TL, T, TR, ETR, L, LL, ELL}.

In another embodiment, missing reference samples may be first substituted following the VVC process (Ref. [10]), where missing reference samples are copied from the nearest available samples in clockwise order. Next, substituted reference samples are smoothed with a corresponding filter, and finally they are normalized by subtracting their mean values. In such a scenario:
\hat{X}_{R} denotes the normalized substituted reference samples in reference region R, if there are missing reference samples in region R; or
\hat{X}_{R} denotes the normalized reference samples in reference region R, if there are no missing reference samples in region R.
2. Adaptive Reference Samples Generation (210)

For each reference region R, there is a corresponding multi-layer perceptron (MLP_{R}) network which receives the pre-processed input \hat{X}. Without limitation, the MLP structure can be a simple feed-forward network with n MLP layers, (e.g., n=2).

For each MLP, the output of the MLP and the corresponding reference region \hat{X}_{R} are added together, and all such outputs are concatenated (212) to generate an input for the neural-network for intra prediction (215).
3. Neural-network prediction (215)
   Any neural-network architecture could be used here, e.g., without limitation, one may use the nnIntra architecture of Ref. [3].
4. Post processing (220)
   This stage reverses the pre-processing stage by reshaping (e.g., from an 1-D array to a 2-D block) and rescaling the predicted pixels to generate the predicted block Ŷ (e.g., by adding back the average value).

This approach offers several advantages. It avoids redundant computation for available samples, allows single network training, and eliminates the need for multiple neural networks for each difference reference sample case.

To constraint the reference sample generation, an additional loss function ( [symbol] _{ref}) is added to [symbol] (x, y, θ) in equation (1) as:

$$ℒ ( x , y ; θ ) = SATD ( y , {f}_{h , w} ( x ; {θ}_{h , w} ) ) + {λ}_{1} \vert {θ}_{h , w} \vert + {λ}_{2} ℒ ( rpIdx , mode ) + {λ}_{3} {ℒ}_{ref} , \qquad ( 2 )$$

where x denotes the output of preprocessing, y denotes the ground truth predicted samples, and λ₃ is weighting factor for generation loss (e.g., λ₃=1.0e⁻¹). The generation loss [symbol] _{ref} is calculated as fidelity loss between the predicted reference samples and the original reference samples as follows:

$${ℒ}_{ref} = {\sum }_{t ∈ 𝕋} {w}_{t} {‖ {R}_{h , w}^{t} ( x , {θ}_{h , w}^{R} ) - {y}_{t} ‖}_{2}^{2} , 𝕋 = \{ TL , T , TR , ETR , L , LL , ELL \} , \qquad ( 3 )$$

$${w}_{t} = \{ \begin{matrix}1 & non available region \\ 0 & otherwise\end{matrix} \qquad ( 4 )$$

where yₜ denotes the ground truth reference samples, and

$${R}_{h , w}^{t} ( x , {θ}_{h , w}^{R} )$$

denotes the predicted reference sample after MLPₜ with corresponding parameters

$${θ}_{h , w}^{R} .$$

In an embodiment, the design of adaptive reference sample generation, neural-network prediction, and post processing may be viewed as a simple neural network layer with fully connected layers. Therefore, one can train the whole network together, in a similar approach as in Ref [3], using the loss function in Eq. (3).

In another embodiment, one may apply separate training stages for adaptive reference sample generation, neural-network prediction, and post processing. First, the adaptive reference sample generation network is trained using the loss function

$$ℒ ( x , y ; θ ) = {ℒ}_{r e f} + {λ}_{31} \vert {θ}_{h , w} \vert , \qquad ( 5 )$$

where, for example, λ₃₁=λ₁=5.0e⁻⁵.
   Next, the neural-network prediction network is trained as described in Ref [3].
In one embodiment, when there are no reference samples available, the neural network prediction stage (215) is skipped.
In another embodiment, instead of adding zeros, the missing reference samples are filled using the VVC substitution method, as described earlier.

### Enhanced Neural Network-Based Post Filtering for Intra Prediction

In an embodiment, it may be beneficial to use an additional neural network as part of intra-prediction post processing, to take advantage of any pixel correlation. FIG. 2B depicts an example of such processing flow where a convolutional neural network (CNN) (225) is added during the post processing. Additional convolutional layers are applied using any existing architecture, like the neural-networks loop filter (NNLF) (Ref. [8, 9]).

Note that such enhancement layers are trained jointly with NN prediction (215) to maximize the potential improvement. In such a scenario, an additional loss function for the CNN enhancement is introduced ( [symbol] ₚₒₛₜ) based on the final enhanced prediction of

$${Y}^{\hat{ˆ}} = {C}_{h , w} ( {f}_{h , w} ( x ; {θ}_{h , w} ) , {θ}_{h , w}^{C} ) , \qquad ( 6 )$$

where C_{h,w}(·) denotes the post-processing CNN with corresponding parameters

$${θ}_{h , w}^{C} .$$

In an embodiment, the total loss function for such a framework is now given by:

$$ℒ ( x , y ; θ ) = SATD ( y , {f}_{h , w} ( x ; {θ}_{h , w} ) ) + {λ}_{1} \vert {θ}_{h , w} \vert + {λ}_{2} ℒ ( rpIdx , mode ) + {λ}_{3} {ℒ}_{r e f} + {λ}_{4} {ℒ}_{post} , \qquad ( 7 )$$

where, for example, λ₄=5.0e⁻², and

$${ℒ}_{post} = ( y , {C}_{h , w} ( {f}_{h , w} ( x ; {θ}_{h , w} ) , {θ}_{h w}^{c} ) ) , \qquad ( 8 )$$

where

$${θ}_{hw}^{c} .$$

denotes the weights/parameters of the post-processing CNN.

It should be noted that any network architecture structure can be adopted for the post-processing enhancement process. In an embodiment, a NN is used with a similar structure as the back-bone network in the NNLF (Ref. [8, 9]).
In one embodiment, the number of layers for neural-network prediction (215) is reduced to one fully connected layer. It serves as an initial prediction result with limited complexity, similar to MIP. In such a scenario, it is possible to use more weights and complexity for the enhancement network to take the advantage of 2-D pixel-correlation.

### Reference Sample Dependent Networks

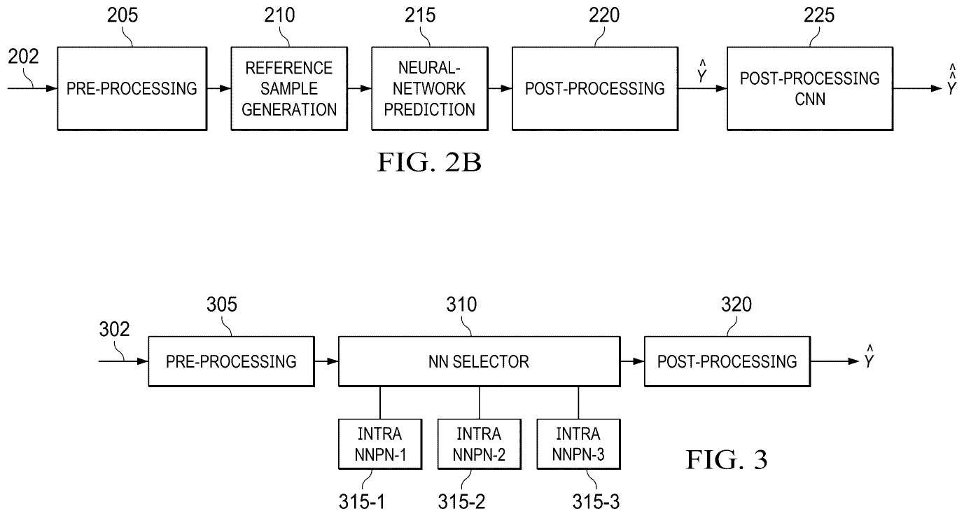

In another embodiment, as depicted in FIG. 3, missing reference samples are handled by training separate neural networks, each trained for reference samples with a different availability pattern. For example, given an input block Y and associated neighboring samples (302) (e.g., see FIG. 1), after pre-processing (305), a neural-networks selector (310) selects an intra neural-network prediction network (I-NNPN) (315) among two or more neural-network prediction networks (NNPN) based on availability of the reference samples. In an embodiment, without limitation, the system may include
1) Network A (315-1): handling cases where only Top, Top Left, and Left samples are available
2) Network B (315-2): handling cases where only Top, Top Left, Top Right, and Left samples are available; and
3) Network C (315-3): handling cases where all reference samples are available and any missing reference samples are substituted using VVC's algorithm Ref. [10].
   Given the selected Intra-NNPN, its output will be post-processed by post-processing 320 to generate the predicted output Ŷ.

The advantage of this method is that prediction is adjusted depending on the availability of reference samples, thereby, improving the prediction accuracy in corresponding reference sample cases. On the other hand, this method increases the number of neural networks required for prediction. In an embodiment, each of these networks may be trained following the training procedure in Ref. [3].

In an embodiment, a post-processing CNN (e.g., 225), may also be added after post-processing (320).

### REFERENCES

Each one of the references listed herein is incorporated by reference in its entirety. The terms JVT, JCT-VC, and JVET refer to Joint Video Experts Teams of ITU-T SG 16 WP 3 (renamed SG21 WP3/21 as of January 2025) and ISO/IEC JTC 1/SC 29.
[1] ITU-T Rec. H.266, “Versatile Video Coding,” ITU-T, August 2020.
[2] J. Pfaff, et al., “Data driven intra prediction modes in the development of the Versatile Video Coding standard”, ITU Journal: ICT Discoveries, Vol. 3 (1), May 2020.
[3] T. Dumas, et al., “Non-EE1: neural network-based intra prediction with learned mapping to VVC intra prediction modes,” JVET-AB0149, JVET 28^{th} meeting, Mainz, DE, October 2022.
[4] T. N. Canh and B. Jeon, “Coding Efficiency of Reference Sample Substitution in HEVC Intra Coding,” in IEIE Workshop on Image Processing and Image Understanding, 2019.
[5] B. Ray, et al., “Non-EE2: Matrix based intra prediction replacing conventional intra modes,” JVET-AG0197, JVET 33d meeting, by teleconference, January 2024.
[6] B. Ray, et al., “EE2-2.13: Matrix based intra prediction replacing conventional intra modes,” JVET-AH0209, JVET 34^{th} meeting, Rennes, FR, April 2024.
[7] H. Wang, et al., “EE2-2.8: Modifications to Matrix-based Intra Prediction,” JVET-AI0208, JVET 35^{th} meeting, Sapporo, JP, July 2024.
[8] F. Galpin, et al., “Description of algorithms version 9 and software version 11 in neural network-based video coding (NNVC)”, JVET-AJ2019, JVET 36^{th} meeting, Kemer, T R, November 2024.
[9] Y. Li, et al., “Designs and Implementations in Neural Network-based video coding,” arXiv 2309.05846v2, 13 Sep. 2023.
[10] J. Pfaff, et al., “Intra prediction and mode coding in VVC,” IEEE Transaction on Circuits and Systems for Video Technologies, Vol. 31, No. 10, pp. 3834-3847 October 2021.

### Example Computer System Implementation

Embodiments of the present invention may be implemented with a computer system, systems configured in electronic circuitry and components, an integrated circuit (IC) device such as a microcontroller, a field programmable gate array (FPGA), or another configurable or programmable logic device (PLD), a discrete time or digital signal processor (DSP), an application specific IC (ASIC), and/or apparatus that includes one or more of such systems, devices or components. The computer and/or IC may perform, control, or execute instructions relating to intra prediction in video coding, such as those described herein. The computer and/or IC may compute any of a variety of parameters or values that relate to intra prediction in video coding as described herein. The image and video embodiments may be implemented in hardware, software, firmware and various combinations thereof.

Certain implementations of the invention comprise computer processors which execute software instructions which cause the processors to perform a method of the invention. For example, one or more processors in a display, an encoder, a set top box, a transcoder, or the like may implement methods related to intra prediction in video coding as described above by executing software instructions in a program memory accessible to the processors. Embodiments of the invention may also be provided in the form of a program product. The program product may comprise any non-transitory and tangible medium which carries a set of computer-readable signals comprising instructions which, when executed by a data processor, cause the data processor to execute a method of the invention. Program products according to the invention may be in any of a wide variety of non-transitory and tangible forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (e.g., that is functionally equivalent), including components which are not structurally equivalent to the disclosed structure which performs the function in the illustrated example embodiments of the invention.

### EQUIVALENTS, EXTENSIONS, ALTERNATIVES AND MISCELLANEOUS

Example embodiments that relate to intra prediction in video coding are thus described. In the foregoing specification, embodiments of the present invention have been described with reference to numerous specific details that may vary from implementation to implementation. Thus, the sole and exclusive indicator of what is the invention, and what is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method to perform intra coding with a neural network, the method comprising:
given a rectangular input pixel block (Y) in a picture:
generating reference pixel samples for predicting pixel values in the input pixel block, wherein the reference pixel samples comprise known reference pixel values and missing reference pixel values from one or more reference regions to the top or to the left of the input block (Y);
preprocessing the reference pixel samples to generate normalized reference samples (\hat{X}), wherein the normalized reference samples are grouped into one or more normalized reference region samples (X_R);
for each of the one or more reference regions (R) generating a region output vector (Z_{R}) comprising the sum of the reference region samples (X_R) and the output of a region-specific multi-layer perceptron (MLP_{R}) which is fed using the normalized reference samples (\hat{X});
concatenating all the output vectors to generate a concatenated output vector;
applying the concatenated output vector to a neural-network prediction network to generate a predicted output vector;
and post-processing the predicted output vector to generate predicted pixel values (Y) for the input block.

2. The method of claim 1, wherein the reference regions comprise one or more of a top left region, a top region, a top right region, an extended top right region, a left region, a lower left region, and an extended lower left region.

3. The method of claim 1, wherein preprocessing the reference pixel samples to generate normalized reference samples comprises:
computing an average of all available refence pixel samples;
subtracting the average from each available reference pixel sample to generate normalized reference samples; and
replacing missing reference samples with normalized reference samples of zero value.

4. The method of claim 3, wherein post-processing the predicted output vector comprises:
adding the average to each pixel value of the predicted output vector to generate the predicted pixel values.

5. The method of claim 1, wherein training the region-specific multi-layer perceptrons and the neural-network prediction network (NNPN) comprises applying during training a loss function:
$$ℒ ( x , y ; θ ) = SATD ( y , {f}_{h , w} ( x ; {θ}_{h , w} ) ) + {λ}_{1} \vert {θ}_{h , w} \vert + {λ}_{2} ℒ ( rpIdx , mode ) + {λ}_{3} {ℒ}_{r e f} ,$$
wherein
x denotes normalized reference samples, y denotes ground truth predicted samples,

|θ_{h,w}| denotes an L1 norm of all learned weights in the NNPN ƒ_{h,w}(x; θ_{h,w}), λ₁, λ₂ λ₃ are constants, [symbol]
(rpIdx, mode) denotes cross entropy loss for intra mode prediction,
SATD stands for sum of absolute transformed differences,
rpIdx denotes an index characterizing a low-frequency non-separable transform (LFNST) kernel index,
mode refers to intra prediction modes,
$${ℒ}_{r e f} = {\sum }_{t ∈ 𝕋} {w}_{t} {‖ {R}_{h , w}^{t} ( x , {θ}_{h , w}^{R} ) - {y}_{t} ‖}_{2}^{2} ,$$ [symbol]
denotes a reference region,
$${w}_{t} = \{ \begin{matrix}1 & missing region \\ 0 & otherwise\end{matrix} ,$$
and
yₜ denotes ground truth reference samples, and
$${R}_{h , w}^{t} ( x , {θ}_{h , w}^{R} )$$
denotes predicted reference samples after the t-th region-specific MLP using weights
$${θ}_{h , w}^{R} .$$

6. The method of claim 1, further comprising applying a convolutional neural network (CNN) C_{h,w}(·) to the predicted pixel values (Y) to generate refined predicted pixel values (\hat{\hat{Ŷ}}).

7. The method of claim 5, wherein training the region-specific multi-layer perceptrons, the neural-network prediction network (NNPN), and a post-processing CNN
$$( {C}_{h , w} ( . , {θ}_{hw}^{c} )$$
with parameters
$${θ}_{h w}^{c}$$
comprises applying during training a loss function:
$$ℒ ( x , y ; θ ) = SATD ( y , {f}_{h , w} ( x ; {θ}_{h , w} ) ) + {λ}_{1} \vert {θ}_{h , w} \vert + {λ}_{2} ℒ ( rpIdx , mode ) + {λ}_{3} {ℒ}_{r e f} + {λ}_{4} {ℒ}_{post} ,$$
wherein,
λ₄ is a constant, and
$${ℒ}_{post} = SATD ( y , {C}_{h , w} ( {f}_{h , w} ( x ; {θ}_{h , w} ) , {θ}_{h w}^{c} ) ) .$$

8. A method to perform intra coding with two or more neural networks, the method comprising:
given a rectangular input pixel block (Y) in a picture:
generating reference pixel samples for predicting pixel values in the input block, wherein the reference pixel samples comprise known reference pixel values and missing reference pixel values from pixel regions to the top or to the left of the input block (Y);
preprocessing the reference pixel samples to generate normalized reference samples (\hat{X}), wherein the normalized reference samples are grouped into one or more normalized reference region samples (X_R);
selecting an intra neural-network prediction network (I-NNPN) among two or more neural-network prediction networks (NNPN) based on availability of the reference samples to process the normalized reference samples and generating output samples; and
post-processing the output samples to generate predicted pixel values (Y) for the input block.

9. The method of claim 8, wherein the two or more NNPNs comprise:
a first NNPN optimized to process normalized reference region samples only when they are available from Top, Top Left, and Left pixel regions;
a second NNPN optimized to process normalized reference region samples only when they are available from Top, Top Left, Top right, and Left pixel regions; and
a third NNPN optimized to process normalized reference region samples when there are no missing reference samples.

10. A tangible computer-readable storage medium having stored thereon computer-executable instructions for executing with one or more processors a method in accordance with the method recited in claim 1.

11. An apparatus comprising a processor and configured to perform the method recited in claim 1.
